(19) United States
(12) Patent Application Publication
(10) Pub. No.: US 2005/0266126 A1
(43) Pub. Date: Dec. 1, 2005

(54) Mr. B's mini-single serve meatloaf

(76) Inventor: Bennie Evans JR., Gerland, TX (US)

Correspondence Address: Bennie Evans Jr., 209 Main Street, Garland, TX, 75040, US

(21) Appl. No.: 10/855,454

(22) Filed: May 27, 2004

(51) Int. Cl. A23B 4/00

(52) U.S. Cl. 426/129

(57) ABSTRACT

Frozen, Pre-Prepared, Pre-Cooked, served in Single Serve loaves in a variety Of sizes, weighing from 5 ounces to 8 ounces, pre-prepared ready to bake and serve, also pre-prepared and pre-cooked ready to heat and serve, and contains a pre-prepared sauce for topping. The meatloaves consist of ground beef, bell peppers, onions, eggs, meatloaf seasoning, flour, tomato paste, and tomato sauce. Shape into individual loaf forms, oven bake on low temperature until done. After baking meatloaves, drain to dispose of excess grease. Meatloaves weigh around 43/4 oz to 51/2 OZ after being baked. Let cool in refrigerator before wraping. The sauce is prepared with Picante Sauce, Ketchup, dash of Worcestershire Sauce, dash of Garlic Powder.

### Detailed Description of Invention

Frozen, Pre-Prepared, Pre-Cooked, served in Single Serve loaves in a variety of sizes, weighing from 1 ounce up to 12 ounces, pre-prepared ready to bake and serve, also pre-prepared and pre-cooked ready to heat and serve, comes with or without fresh bacon or bacon bits and pre-prepared sauce for topping.

1. There is currently no Mini - Single Serve sized Pre-Cooked Meatloaf Product on the market that is served in a variety of sizes. The Mini—Single Serve sized Meatloaves range from 4¾ ounces to 5½ ounces. Marketable to School Cafeterias, Grocery Stores, Restaurant Conversaries and Military Conversaries. This Mini—Single Serve Meatloaf stays firm while remaining moist after cooking.
